(19) United States
(12) Patent Application Publication
(10) Pub. No.: US 2010/0172634 A1
(43) Pub. Date: Jul. 8, 2010

(54) Content Distribution Systems and Methods

(75) Inventors: Gilles Bruno Marie Devictor, Milpitas, CA (US); Shlomo Selim Rakib, Cupertino, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/350,877

(22) Filed: Jan. 8, 2009

(51) Int. Cl. H04N 5/91; H04N 11/04

(52) U.S. Cl. 386/123; 375/240.01; 386/E05.001; 375/E07.026

(57) ABSTRACT

A content distribution system and method receives content from a content source and encodes the received content to generate encoded content. The encoded content is modulated to generate modulated content. A frequency is selected for distributing the modulated content. A determination is made regarding whether the selected frequency is available for distributing the modulated content. If the selected frequency is not available, alternate frequencies are selected until an available frequency is identified. If the selected frequency is available, the modulated content is then distributed using the selected frequency. Existing display devices equipped with appropriate tuners do not need any additional hardware or software to receive such content.

### BACKGROUND

The invention relates generally to systems and methods for wirelessly distributing content from a content source to a content destination. In particular, the described systems and methods receive content and identify an available frequency segment for wirelessly distributing the received content to a content destination, such as a display device having a tuner.

Using existing systems to wirelessly distribute content to a display device typically requires a specific wireless receiver located within the display device or coupled to the display device. For example, using existing systems to wirelessly distribute video content to a television requires a DMA (digital media adapter) or similar device to convert the broadcast signal to a signal format that can be processed by the television. This DMA may be incorporated into the television or a separate device coupled to the television. Requiring a DMA increases the cost to the consumer due to a more complex television or requiring the purchase of the separate DMA device. Such systems are also inconvenient as they may require a consumer to purchase different DMA devices (or purchase different televisions) to support new wireless distribution formats developed in the future.

Another approach to distributing content to a television using known systems utilizes existing cable television wiring within a building to distribute the desired content. Although the existing cable television wiring may be capable of distributing the content, such distribution may interfere with other signals transmitted on the same wiring by the cable service provider. Additionally, such distribution of content is not typically authorized by the cable service provider and may cause the improper operation of other systems or devices coupled to the same cable system.

### BRIEF DESCRIPTION OF THE DRAWINGS

FIG. 1 shows an example system capable of implementing content broadcasting.

FIG. 2 is a flow diagram showing an embodiment of a procedure for distributing content.

FIGS. 3A-3B show embodiments of a range of frequencies segmented into multiple broadcast channels and multiple shared white spaces.

FIG. 4 is a flow diagram showing an embodiment of a procedure for distributing two different programs to two different display devices simultaneously.

FIG. 5 is a flow diagram showing an embodiment of a procedure for implementing a remote desktop service.

Throughout the description, similar reference numbers may be used to identify similar elements.

### DETAILED DESCRIPTION

The systems and methods described herein receive content from a content source and wirelessly distribute the content to a content destination. In a particular implementation, the systems and methods receive video content from a content source, identify an available TV white space for distributing the video content, and broadcast the video content in an established standard format to one or more display devices capable of receiving, processing and displaying the video content. TV white space is the space between broadcast TV channels. The described systems and methods distribute the video content to a display device, which can receive the content without requiring the use of a digital media adapter (DMA) located within the display device or coupled to the display device. Instead, the display device uses its existing tuner (or related components) to receive the distributed video content, thereby allowing legacy display devices to receive the video content without modification. Thus, the described systems and methods permit the distribution of content to any display device capable of tuning the appropriate frequency and decoding, if necessary, the distributed video content. The terms “broadcasting content” and “distributing content” are used interchangeably herein.

Although particular examples discussed herein refer to video content, video display devices, and the like, the systems and methods discussed herein can be used with any type of distribution device and any type of content destination capable of receiving and processing the distributed content. Specific embodiments discussed herein refer to video content, such as a television program or a movie. Alternate embodiments may process any type of content, such as audio content, graphical images, text content, and the like.

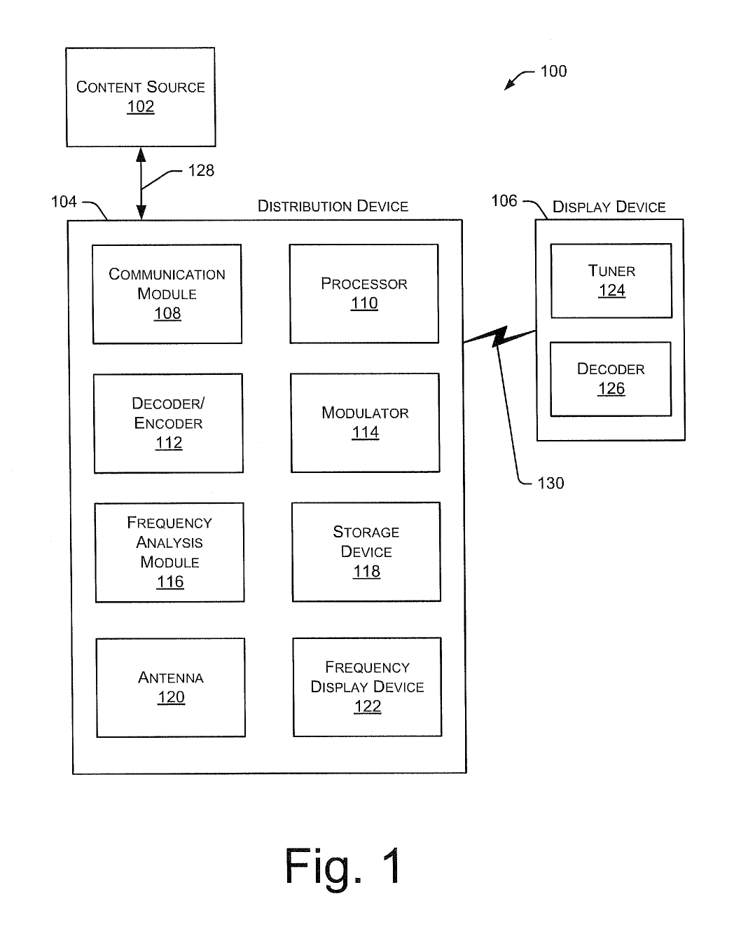

FIG. 1 shows an example system 100 capable of implementing content distribution as described herein. System 100 includes a content source 102, a distribution device 104 and a display device 106. Content source 102 is any system or service capable of providing content to distribution device 104. Content source 102 may be located remotely from distribution device 104 or may be local to distribution device 104. Content source 102 may provide any type of content, such as video content, audio content, text content, data content and the like. Example content sources 102 include databases, storage devices (e.g., hard disk drives), servers, content service providers, DVD players, Blu-ray Disc™ players, digital video recorders, audio players, game consoles, computing systems and so forth. Although one content source 102 is shown in FIG. 1, alternate embodiments may include any number of content sources 102 coupled to distribution device 104.

Content is communicated from content source 102 to distribution device 104 via a communication link 128 using any communication medium and any communication protocol. In a particular embodiment, content is streamed from content source 102 to distribution device 104 via the Internet or other data communication network. In another embodiment, content is retrieved from content source 102 by distribution device 104 via a wired or wireless communication link.

Distribution device 104 is capable of receiving content from content source 102, processing the received content as discussed herein, and distributing (also referred to herein as “broadcasting”) the content to one or more display devices 106, which display or otherwise present the content received from distribution device 104. In the described embodiments, distribution device 104 distributes content unidirectionally to one or more display devices 106. For example, distribution device 104 may wirelessly broadcast content in one direction from distribution device 104 to one or more display devices 106. Thus, distribution device 104 does not receive feedback signals (e.g., error checking signals, arbitration signals, and the like) from any display device 106. Any control feedback for distribution device 104 will use a separate communication link, such as an RF (radio frequency) signal from a remote control device.

Example display devices 106 include a monitor, television, or video projector. Content is communicated from distribution device 104 to display device 106 via a wireless communication link 130 using any communication protocol commonly supported by tuners contained in display devices. Example communication protocols include those developed by ATSC (Advanced Television Systems Committee) and NTSC (National Television System Committee). Although one display device 106 is shown in FIG. 1, alternate embodiments may include any number of display devices coupled to distribution device 104.

Distribution device 104 includes a communication module 108, a processor 110, a decoder/encoder 112, a modulator 114, a frequency analysis module 116, a storage device 118, an antenna 120 and a frequency display device 122. Although not shown in FIG. 1, these components of distribution device 104 communicate with one other via one or more communication links, such as buses, within distribution device 104. Communication module 108 communicates content and other data between distribution device 104 and other devices, such as content source 102, display device 106, and so forth. Processor 110 performs various operations necessary during the operation of distribution device 104. For example, processor 110 performs several methods and procedures discussed herein to retrieve, encode, modulate and distribute various content.

Decoder/encoder 112 decodes the content received from content source 102 and re-encodes it into one or more formats supported by display device 106, such as MPEG 2 (Moving Picture Experts Group) or H.264 (also referred to as MPEG4 AVC (advanced video coding)). Alternatively, decoder/encoder 112 may convert the received content into an analog standard definition television signal for use with legacy televisions. Modulator 114 modulates the encoded content generated by decoder/encoder 112 into one or more modulated formats, such as QAM (Quadrature Amplitude Modulation), 8VSB (8-level vestigial sideband modulation) for ATSC standards, or NTSC standards. Modulation using an NTSC standard is particularly useful when supporting legacy televisions. As discussed herein, frequency analysis module 116 identifies frequencies (or frequency segments) available for distributing the modulated content and selects an available frequency. Frequency analysis module 116 may identify available frequencies by analyzing the local spectrum and/or may use a database of available frequencies for its location. Storage device 118 stores data and other information used during the operation of distribution device 104. Storage device 118 may include one or more volatile and/or non-volatile memories. In a particular embodiment, storage device 118 includes a hard disk drive as well as volatile and non-volatile memory devices. Antenna 120 is used to transmit the modulated content from distribution device 104 to a display device 106. Antenna 120 transmits a low power signal to reduce the likelihood of interference with other TV white space devices. Frequency display device 122 displays the frequency selected for distributing content from distribution device 104 to display device 106 or to a remote control device. This displayed frequency information is applied by a user to tune the display device to an appropriate frequency or channel to receive the distributed content. In one embodiment, an IR (infrared) repeater is used to send channel control change signals to display device 106 from distribution device 104, thereby automatically tuning the appropriate channel on display device 106.

In particular embodiments of distribution device 104, one or more illustrated components represent computer-readable instructions that are executed, for example, by processor 110. For example, decoder/encoder 112, modulator 114 and frequency analysis module 116 may be implemented as computer-readable instructions that are executed by processor 110.

Distribution device 106 includes a tuner 124 and a decoder 126. Tuner 124 is capable of tuning multiple frequencies on which content may be distributed by distribution device 104. Decoder 126 decodes the received content using a decoding procedure that corresponds to the encoding format used by decoder/encoder 112 in distribution device 104. For example, decoder 126 may decode formats such as MPEG 2 or H.264. Although not shown in FIG. 1, tuner 124 and decoder 126 communicate with each other via one or more communication links within display device 106. In particular embodiments of display device 106, tuner 124 and/or decoder 126 are implemented as computer-readable instructions that are executed, for example, by a processor (not shown).

In a particular implementation, distribution device 104 is a general purpose computer system capable of performing the procedures described herein. In this implementation, content source 102 is an external storage device coupled to the general purpose computer, such as an external hard disk drive, a DVD player, or a Blu-ray Disc™ player. Alternatively, content source 102 is located remotely from the general purpose computer such that the general purpose computer receives content via the Internet or other data communication network. In this situation, the general purpose computer may temporarily store the received content on its internal storage device 118 to facilitate decoding, encoding, modulating and distributing the content to display device 106.

In another embodiment, content source 102 is contained within distribution device 104. In this embodiment, content source 102 is a storage device, such as a hard disk drive, a DVD drive, or a Blue-ray Disc™ drive contained within distribution device 104.

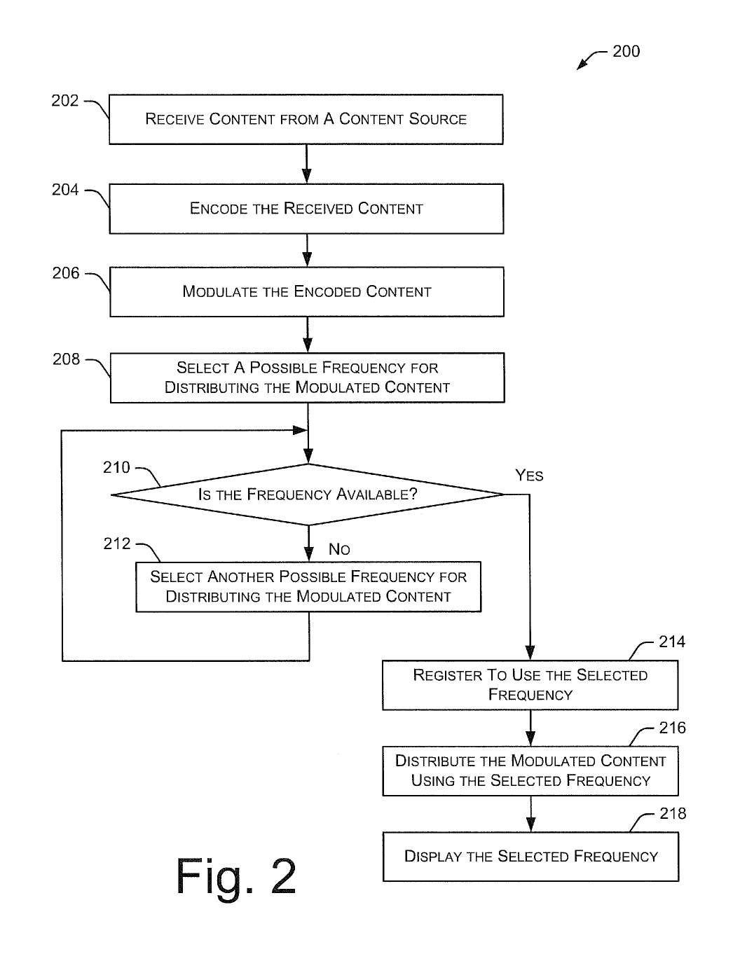

FIG. 2 is a flow diagram showing an embodiment of a procedure 200 for distributing content. Initially, procedure 200 receives content from a content source (block 202), such as content source 102 shown in FIG. 1. Content can be received via a “push” or a “pull” data transfer. For example, the content can be retrieved (e.g., pulled) from the content source by actively retrieving the desired content, such as retrieving content from a hard disk drive. Alternatively, the content can be “pushed” from the content source (e.g., “pushed” by a server via the Internet or other data communication network). Procedure 200 continues by encoding the received content (block 204). As mentioned above, various encoding techniques can be applied to the received content, such as MPEG2, H.264, or converting the content into an analog standard definition television signal for use with legacy televisions. In an alternate embodiment, the procedure first decodes the received content then encodes the content using an encoding format that can be decoded by a display device. After encoding the received content, the procedure modulates the encoded content (block 206). As mentioned above, various modulation techniques can be applied to the encoded content, such as QAM, ATSC, or NTSC (when supporting legacy televisions).

Procedure 200 continues by selecting a possible frequency for distributing the modulated content (block 208). As discussed herein, particular embodiments can select from multiple pre-defined frequencies for distributing the modulated content. Although there are several “possible” frequencies for distributing the modulated content, one or more of those frequencies may be in use by other systems. Thus, the procedure selects a first possible frequency and determines whether that selected frequency is available for distributing the modulated content (block 210). This determination regarding frequency availability is performed by “sniffing” the channel to identify “white noise” or to identify an active signal. A database of licensed frequencies for a given location can also be used to determine which frequencies are unlicensed and safe to “sniff”. When required by regulation, a geolocation device such as a GPS (global positioning system) can be added to frequency analysis module 116. If the procedure detects white noise, then the channel is available. If the procedure detects an active signal, then another device is using the selected channel, and a different frequency is selected. If the first selected frequency is not available, the procedure selects another possible frequency for distributing the modulated content (block 212). This frequency selection process continues until an available frequency is selected (i.e., a frequency that is not currently in use by another system). In a particular embodiment, the process of “sniffing” a channel is similar to the methods used by televisions and set-top boxes when performing channel lineup detection.

After an available frequency is selected, procedure 200 may registers to use the selected frequency (block 214) if such a registration is required. Registering the selected frequency prevents other systems from using that same frequency and interfering with distribution of the modulated content to the display device. This registration of the selected frequency may be temporary, such that the registration is released after distribution of the modulated content is complete. In a particular embodiment, distribution devices below a particular transmission power level (e.g., 50 mW) using TV white space do not need to register. However, distribution devices below the particular transmission power level may still access a database of TV white space devices to determine the availability of channels or other information.

After registering the selected frequency, procedure 200 distributes the modulated content using the selected frequency (block 216). Finally, the procedure displays the selected frequency (block 218), which allows a user to tune the display device to an appropriate frequency or channel to receive the distributed content. Although not shown in FIG. 2, when the procedure finishes distributing the modulated content using the selected frequency, it releases (or “unregisters”) the selected frequency to allow other systems to use the same frequency.

In a particular embodiment, the display device is capable of tuning multiple television channels, where each television channel is associated with a particular frequency (or frequency segment). User input (e.g., identifying a particular television channel) provided to the display device via a remote control device instructs the display device to display content associated with the particular television channel. If the user wants to view the distributed content (e.g., using procedure 200 discussed above), the user tunes the display device to the channel (or frequency) displayed at block 218.

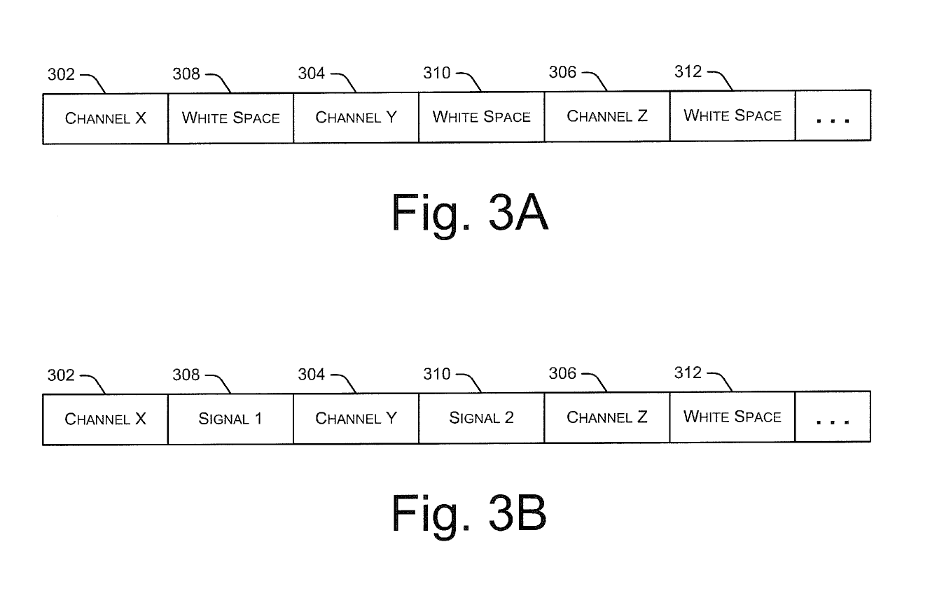

FIGS. 3A-3B show embodiments of a range of frequencies segmented into multiple channels and multiple shared white spaces (also referred to as “TV white spaces”). TV white spaces are the spaces between broadcast TV channels (e.g., the space between channel 2 and channel 3). In the example of FIG. 3A, a range of frequencies is illustrated as having multiple channels 302, 304 and 306, and multiple white space segments 308, 310 and 312. Channels 302, 304 and 306 may also be referred to as “frequency segments”. In a particular embodiment, channels 302, 304 and 306 are pre-determined frequency segments that have assigned channel indicators, such as “Channel 2” or “Channel 50” as used in conventional television broadcasts. In one embodiment, each channel 302, 304 and 306 has a frequency “width” of approximately 6 MHz. In this embodiment, each white space segment 308, 310 and 312 also has a frequency “width” of approximately 6 MHz.

White space segments 308, 310 and 312 are interspersed among channels 302, 304 and 306. White space segments 308, 310 and 312 are “shared” frequency segments available for use by multiple distribution devices. If a particular white space segment is available, a specific distribution device can temporarily reserve the white space segment (if reservation is required) for distributing content to one or more display devices. The distribution device releases the white space segment when it finishes distributing the content, thereby allowing other devices or systems to use the same white space segment.

The arrangement shown in FIG. 3A alternates between channels and white space segments. In other embodiments, the channels and white space segments may be arranged in a different order and are not necessarily alternating or in any other regular pattern. Although FIG. 3A identifies three specific channels 302, 304 and 306, and three specific white space segments 308, 310 and 312, alternate embodiments of a particular frequency range may include any number of channels and any number of white space segments arranged in any order.

FIG. 3B illustrates the range of frequencies shown in FIG. 3A in which two of the white space segments (308 and 310) are already used by a particular device. As shown in FIG. 3B, white space segment 308 is distributing data labeled “Signal 1” and white space segment 310 is distributing data labeled “Signal 2”. Thus, if a distribution device wants to distribute content using the range of frequencies shown in FIG. 3B, the distribution device can select white space segment 312, which is not currently being used.

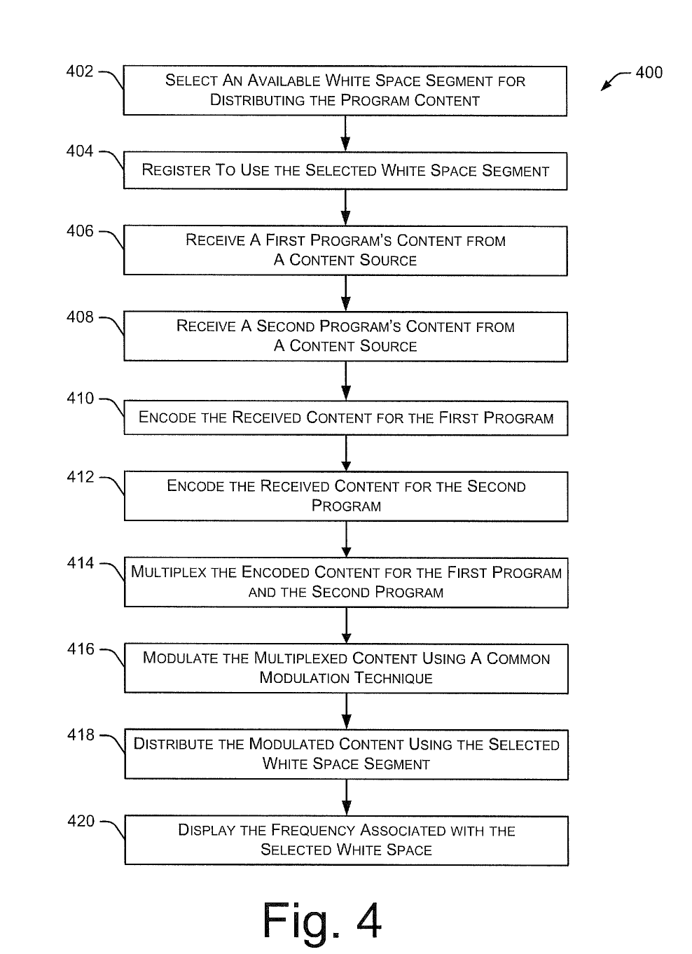

FIG. 4 is a flow diagram showing an embodiment of a procedure 400 for distributing two different programs to two different display devices simultaneously using a single white space segment of the type shown in FIGS. 3A and 3B. In a particular embodiment, the procedure of FIG. 4 distributes two different programs in HD (high definition) format, modulated using QAM, to the two display devices at the same time. Initially, procedure 400 selects an available white space segment for distributing the program content (block 402). As discussed herein, an available white space segment is one that is not already used by another TV white space system or device. If registration is required, the procedure registers to use the selected white space segment (block 404). If such registration is not required, this registration process can be omitted. Procedure 400 then receives a first program's content from a content source (block 406) and receives a second program's content from a content source (block 408). The first program content and the second program content may be received from the same content source or different content sources. Additionally, the first program and the second program need not be related to one another.

The procedure continues by encoding the received content for the first program (block 410) and encoding the received content for the second program (block 412). The first and second programs may be encoded using the same encoding format or they may be encoded using different encoding formats. In a particular example, the first program is encoded using a specific format supported by one display device, and the second program is encoded using a specific format supported by the other display device. If both display devices support the same encoding format, then the first and second programs can be encoded using the same format.

Procedure 400 then multiplexes the encoded content for the first program and the second program (block 414). Next, the procedure modulates the multiplexed content for the first and second programs using the same modulation technique (block 416). For example, the first and second programs can be multiplexed as two adjacent digital subchannels, such as 36.1 and 36.2. The procedure continues by broadcasting the modulated content using the selected white space segment (block 418). Since two different programs are broadcast in the selected white space segment, the display device 106 uses the subchannel PID (packet identifier) to extract the video program intended for that device in the same manner that a digital TV or set-top box extracts several subprograms from a single physical 6 MHz signal. The subchannel PID associates a particular packet with a program (or other content) within the transport stream. In a particular embodiment, the identifier associated with each program is the ATSC PID. For example, if the selected white space is associated with channel 36, the first program has an associated virtual channel number of 36.1 and the second program has an associated virtual channel number of 36.2. Finally, the procedure displays the frequency associated with the selected white space (block 420). In the example mentioned above (using channel numbers 36.1 and 36.2), procedure 400 may alternately display the two channel numbers (e.g., 36.1 and 36.2) associated with the two programs.

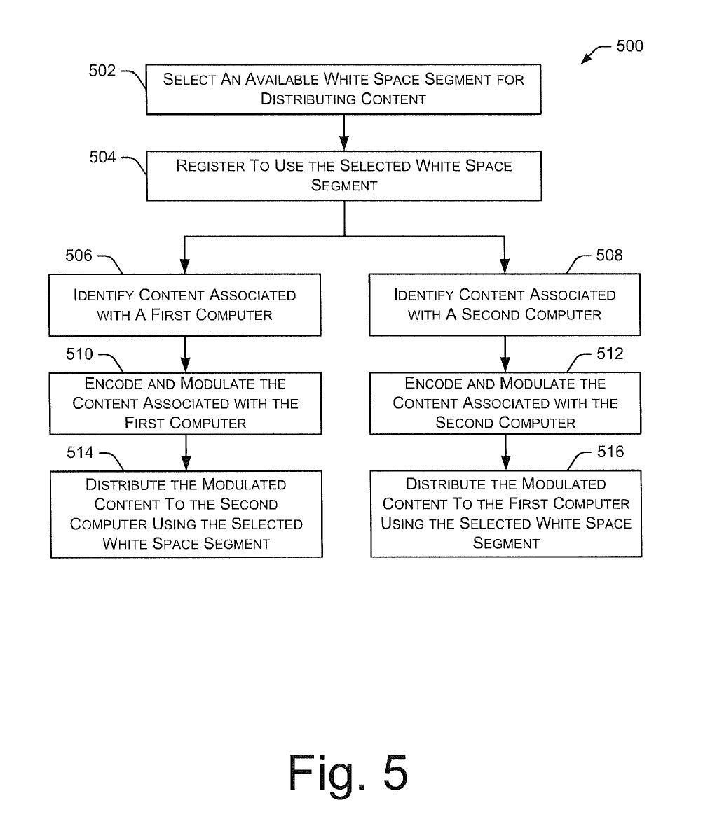

FIG. 5 is a flow diagram showing an embodiment of a procedure 500 for implementing a remote desktop service between two computer systems. A remote desktop service allows a user of one computer to access a remote computer system and control the remote computer system. The user's local computer system typically displays what the user would see if physically present at the remote computer system. In the embodiment of FIG. 5, the procedure is capable of communicating data between the two computer systems by establishing two separate distribution links (one distribution link from the first computer to the second computer, and a second distribution link from the second computer to the first computer). This embodiment supports the distribution of high quality video content between the two computers (e.g., video content at approximately 60 frames per second or better) by using two separate white space segments.

Initially, procedure 500 selects an available white space segment for distributing content (block 502). In one embodiment, a separate white space segment is used for each distribution of content. Procedure 500 continues by registering to use the selected white space segment (or segments) at block 504 if required by regulation or otherwise required. The procedure then begins the remote desktop service by allowing a first computer and a second computer to exchange data via two separate one-way distribution links (one distribution link from the first computer to the second computer, and the other distribution link from the second computer to the first computer). In this embodiment, the “desktop” of one computer can be encoded as video content and distributed as a television program to the other computer. Similarly, a PID can be used to identify content as data to be broadcast from one computer to the other.

Blocks 506 and 508 identify content associated with a first computer and a second computer, respectively. Blocks 510 and 512 encode and modulate the content associated with the first computer and the second computer, respectively. Finally, blocks 514 and 516 distribute the modulated content to the second computer and the first computer using the selected white space segment, respectively. Blocks 506, 510 and 514 are typically performed in parallel with blocks 508, 512 and 516. This process of identifying content, encoding content, modulating content and distributing content continues for the duration of the remote desktop session.

In another embodiment of a remote desktop service, a first computer is the “controller” and a second computer is the “source”. The source will distribute its content and display information to the controller using a high speed connection, such as described herein. The controller can use a lower speed connection to send control commands (e.g., keyboard inputs) to the source computer. This embodiment uses a single white space segment.

An alternate embodiment of a remote desktop service uses a single white space segment and multiplexes the white space segment in time. A first computer transmits data during a first time period (such as the first 800 milliseconds), then a second computer transmits data during a second time period (such as the next 200 milliseconds). This embodiment supports two separate transport streams using the same white space segment, but separated in time. Each computer can use the entire 6 MHz of the white space segment, but only during its assigned time slot. In a particular example, both computers buffer received video content to smooth the content before displaying the content to a user. Any number of computers can share a single white space segment in the same manner by multiplexing the white space segment in time. Multiple time slots can be allocated using a round robin technique or any other allocation technique.

In one embodiment, distribution device 104 shown in FIG. 1 is a computer capable of performing various operations. In this embodiment, the computer is operating as a digital video recorder (DVR) without requiring the addition of any new devices to the computer. For example, the computer uses its existing hard disk drive, processor and other components to implement the DVR functionality. The computer performs some or all of the procedure shown in FIG. 2, as needed, to wirelessly communicate content from the computer to one or more display devices located in the same general area as the computer, such as in the same building or local geographic area. While operating as a DVR, the computer is able to perform other operations simultaneously. The computer may also be configured to operate as a multi-room DVR without requiring any additional adapters or other devices for existing televisions or set-top boxes. The computer distributes two or more programs (or other content) to different display devices, each of which as a tuner to receive the content. A single computer operating as a DVR can distribute multiple programs within a single white space segment based on the bandwidth allowed by the modulation technique.

Embodiments of the systems and methods described herein facilitate the distribution of content, such as video content, to one or more content destinations without a need for additional reception hardware. Additionally, some embodiments may be used in conjunction with one or more conventional video processing and/or video display systems and methods. For example, one embodiment may be used as an improvement of existing video processing systems.

Although the components and modules illustrated herein are shown and described in a particular arrangement, the arrangement of components and modules may be altered to perform the selection and presentation of advertisements to users in a different manner. In other embodiments, one or more additional components or modules may be added to the described systems, and one or more components or modules may be removed from the described systems. Alternate embodiments may combine two or more of the described components or modules into a single component or module.

Although specific embodiments of the invention have been described and illustrated, the invention is not to be limited to the specific forms or arrangements of parts so described and illustrated. The scope of the invention is to be defined by the claims appended hereto and their equivalents.

1. A method comprising:
receiving content from a content source;
encoding the received content to generate encoded content;
modulating the encoded content to generate modulated content;
selecting a frequency for wirelessly distributing the modulated content;
determining whether the selected frequency is available for wirelessly distributing the modulated content;
if the selected frequency is not available, selecting alternate frequencies until an available frequency is selected; and
wirelessly distributing the modulated content using the selected frequency if the selected frequency is available.

2. The method of claim 1, wherein the selected frequency is a TV white space.

3. The method of claim 1, wherein wirelessly distributing the modulated content is unidirectional.

4. The method of claim 1, wherein encoding the received content includes encoding the received content in a manner that allows existing display devices to decode the encoded content.

5. The method of claim 1, wherein modulating the encoded content includes modulating the encoded content in a manner that allows existing display devices to tune the modulated content.

6. The method of claim 1, wherein wirelessly distributing the modulated content using the selected frequency includes microbroadcasting the modulated content.

7. The method of claim 1, wherein wirelessly distributing the modulated content using the selected frequency includes wirelessly distributing the modulated content in a limited geographic area using low power.

8. The method of claim 1, wherein the content is video content.

9. The method of claim 1, wherein the content is high definition television content.

10. The method of claim 1, wherein encoding the received content includes encoding the received content using MPEG2.

11. The method of claim 1, wherein encoding the received content includes encoding the received content using H.264.

12. The method of claim 1 wherein encoding the received content includes converting the received content into an analog standard definition television signal.

13. The method of claim 1, wherein modulating the encoded content includes modulating the encoded content using Quadrature Amplitude Modulation.

14. The method of claim 1, wherein modulating the encoded content includes modulating the encoded content using an Advanced Television Systems Committee standard.

15. The method of claim 1, wherein modulating the encoded content includes modulating the encoded content using a National Television System Committee standard.

16. The method of claim 1, wherein selecting a frequency for wirelessly distributing the modulated content includes identifying at least one frequency associated with white space microbroadcasting.

17. The method of claim 1, wherein determining whether the selected frequency is available for wirelessly distributing the modulated content includes determining whether the selected frequency contains white noise.

18. The method of claim 1, wherein determining whether the selected frequency is available for wirelessly distributing the modulated content includes determining whether the selected frequency contains active signals.

19. The method of claim 1, further comprising displaying the selected frequency on a distribution device handling wireless distribution of the modulated content.

20. The method of claim 1, further comprising registering to use the selected frequency if the selected frequency is available.

21. A method comprising:
receiving content associated with a first program;
receiving content associated with a second program;
encoding the content associated with the first program;
encoding the content associated with the second program;
modulating the encoded content associated with the first and second programs;
selecting a white space segment for distributing the modulated content;
wirelessly distributing the modulated content to a first display device using the selected white space segment; and
wirelessly distributing the modulated content to a second display device using the selected white space segment.

22. The method of claim 21, further comprising receiving and encoding content associated with a third program, wherein the encoded content associated with the third program is modulated along with the encoded content associated with the first and second programs.

23. The method of claim 21, wherein the first program is encoded using a first encoding technique and the second program is encoded using a second encoding technique.

24. The method of claim 21, wherein the content associated with the first program is received from a first content source and the content associated with the second program is received from a second content source.

25. The method of claim 21, wherein wirelessly distributing the modulated content includes wirelessly distributing the modulated content in a limited geographic area using low power.

26. The method of claim 21, wherein the content associated with the first program and the content associated with the second program is high definition video content.

27. The method of claim 21, further comprising multiplexing the encoded content associated with the first and second programs prior to modulating the content.

28. The method of claim 21, wherein the selected white space segment is a TV white space segment.

29. An apparatus comprising:
a communication module configured to receive content from a content source;
an encoder coupled to the communication module and configured to encode the received content and to generate encoded content;
a modulator coupled to the encoder and configured to modulate the encoded content and to generate modulated content;
a frequency analysis module configured to select a TV white space for wirelessly distributing the modulated content, wherein the frequency analysis module is further to determine whether the selected TV white space is available for wirelessly distributing the modulated content; and
an antenna coupled to the modulator and configured to wirelessly distribute the modulated content to a display device using the selected TV white space if the selected TV white space is available.

30. The apparatus of claim 29, wherein the frequency analysis module is further configured to select an alternate TV white space if the selected TV white space is not available.

31. The apparatus of claim 29, wherein the modulator generates the modulated content such that the display device uses its existing tuner to receive the modulated content.

32. The apparatus of claim 29, wherein the encoder generates the encoded content such that the display device uses its existing decoder to decode the received content.

33. The apparatus of claim 29, wherein the apparatus is a general purpose computer.

34. The apparatus of claim 29, wherein the antenna distributes the modulated content unidirectionally.
